(19) United States
(12) Patent Application Publication
(10) Pub. No.: US 2008/0049988 A1
(43) Pub. Date: Feb. 28, 2008

(54) Method of, and System for, Accessing a Home or Dwelling

(75) Inventors: Mark Basile, Jericho, NY (US); Steven Kang, Jericho, NY (US)

Correspondence Address: WILLIAM COLLARD;COLLARD & ROE, P.C., 1077 NORTHERN BOULEVARD, ROSLYN, NY, 11576, US

(73) Assignee: BIOMETRX TECHNOLOGIES, INC, JERICHO, NY (US)

(21) Appl. No.: 11/568,391

(22) PCT Filed: Apr. 6, 2005
(86) PCT No.: PCT/US05/11988

§ 371 Date: Apr. 11, 2007

Related U.S. Application Data
(63) Continuation-in-part of application No. 10/818,655, filed on Apr. 6, 2004, now abandoned.

(51) Int. Cl. G06K 9/00

(52) U.S. Cl. 382/124

(57) ABSTRACT

A biometric device comprising a scanner for reading a user's fingerprint. There can be at least one communication device in communication with the scanner. There can also be a control unit in communication with this scanner, this control unit can be for receiving biometric information from the scanner in the form of for example, a fingerprint. This control unit can be for controlling a remote device. There can also be a remote keypad, which can selectively communicate with said scanner, wherein this remote keypad can be used to adjust controls in the control unit to perform at least one of the following functions: selectively add a user, selectively delete a user or to review a list of users enrolled. The keypad can be in the form of a non-powered keypad or in the form of a cell phone, or PDA.

### CROSS REFERENCE TO RELATED APPLICATIONS

This application is a continuation-in-part application and hereby claims priority from U.S. application Ser. No. 10/818,655 filed on Apr. 6, 2004 wherein the disclosure of which is hereby incorporated herein by reference.

### BACKGROUND OF THE INVENTION

### Field of the Invention

The present invention relates to a device and a system for a fingerprint based biometric device in a stand-alone self-contained unit that can be used to control access to particular electronic devices in a person's home. The need for improved access methods beyond physical keys and codes has accelerated research and development in the biometrics field. It is now possible to have a small self contained biometric driven device that can be used to control electronic components in a user's home.

Other biometric devices are known in the art, for example, U.S. Pat. No. 6,715,674 to Schneider et al issued on Apr. 6, 2004, U.S. Pat. No. 6,484,260 to Scott et al issued on Nov. 19, 2002, and U.S. Pat. No. 6,644,557 to Jacobs et al which issued on Nov. 11, 2003 wherein the disclosures of these patents are hereby incorporated herein by reference.

### SUMMARY OF THE INVENTION

The one embodiment of the invention relates to a biometric device comprising a scanner for reading a user's fingerprint. There can be at least one communication device in communication with the scanner. There can also be a control unit in communication with this scanner. This control unit can be for receiving biometric information from the scanner in the form of for example, a fingerprint. This control unit can be for controlling a remote device. There can also be a remote keypad, which can selectively communicate with this scanner, wherein this remote keypad can be used to adjust controls in the control unit to perform at least one of the following functions: selectively add a user, selectively delete a user or to review a list of users enrolled.

The above embodiment or an alternative embodiment may include A biometric device comprising at least one scanner for reading a user's fingerprint. This scanner can comprise a scanner housing, a scanner fingerpad coupled to the scanner housing, at least one memory element disposed within the scanner housing, a processor disposed in the scanner housing and in communication with the scanner fingerpad, the memory element and the communication device. The processor can be for processing information received from the scanner fingerpad. There can also be a communication device in communication with the scanner, and a control unit in communication with the scanner. The control unit can be for receiving biometric information from the scanner, wherein this control unit can be for controlling a remote device.

There can also be a remote keypad, which can selectively communicate with this scanner, wherein this remote keypad can be used to adjust controls in this control unit to perform at least one of the following functions: selectively add a user, selectively delete a user, or to review a list of users enrolled. There can also be either a garage door opener, or alternatively a thermostat in communication with the control unit, wherein a user can selectively open or close a garage door only after being authenticated by using a select process. The process can include placing a finger on the scanner, scanning the finger for a fingerprint, next, having scanned fingerprint information sent onto the control unit, wherein the control unit compares the scanned fingerprint information to a fingerprint template stored in the control unit, and then the control unit can selectively authenticate the said user if the scanned fingerprint information is matched with the stored fingerprint template, so that the user can open a garage door or operate a thermostat.

Other remote devices other than a garage door or a thermostat could be controlled in this manner as well.

The remote keypad can be in the form of a non powered keypad that receives power from a power connection on the scanner. Alternatively the remote keypad can be in the form of a powered cell phone or a PDA. The remote keypad can communicate with either the control unit or with the scanning element via either a wire connection, wirelessly such as through blue tooth or 802.11a, 802.11b, 802.11g communication, or alternatively through infrared communication as well.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a front view of a first embodiment of the biometric system;

FIG. 2 shows a schematic block diagram of the scanner;

FIG. 3 shows a first implementation of the biometric system;

FIG. 4 shows another implementation of the biometric system;

FIG. 5 shows a schematic block diagram of the control unit;

FIG. 6 shows an embodiment of the keypad;

FIG. 7 shows a flow chart for a process for enrolling a user;

FIG. 8 shows a flow chart for a process for authenticating a user;

FIG. 9 shows another flow chart showing an alternative process for reviewing or changing information in the control unit; and

FIG. 10 is another view of alternative keypads.

### DETAILED DESCRIPTION OF PREFERRED EMBODIMENTS

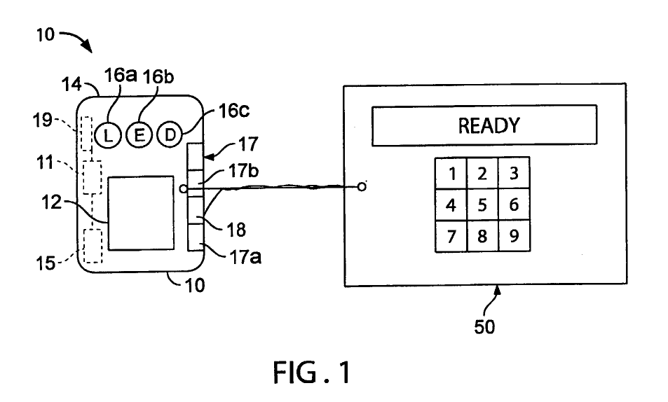

Turning now in detail to the drawings, FIG. 1 shows a fingerprint sensor unit or biometric device 10 that can be used to authenticate a user for electronic components in a household. This fingerprint sensor can either be in wireless communication with, or wired to a device such as a garage door opener or a thermostat.

This device can include a fingerprint pad 12 for receiving a finger, a body or housing 14, and a plurality of LED lights 16a, 16b, 16c which can be used to indicate a reading of a user's biometric information. For example, if a user places his or her finger on the pad, the fingerprint pad 12 can then be used to optically read the fingerprint to authenticate the user. At that time the LED lights 16a, 16b, 16c would transfer from red 16a which indicates that the device is on or operating (ready), to yellow 16b which indicates that the device that the device is reading the fingerprint (wait), to green 16c which indicates that the user's biometric identity has been authorized (success). Essentially these LED indicators can signal four different states: ready, wait, success, or fail status. Thus, if the fingerprint is not authenticated then the green LED light 16c does not light and instead the red LED light 16a lights instead indicating failure.

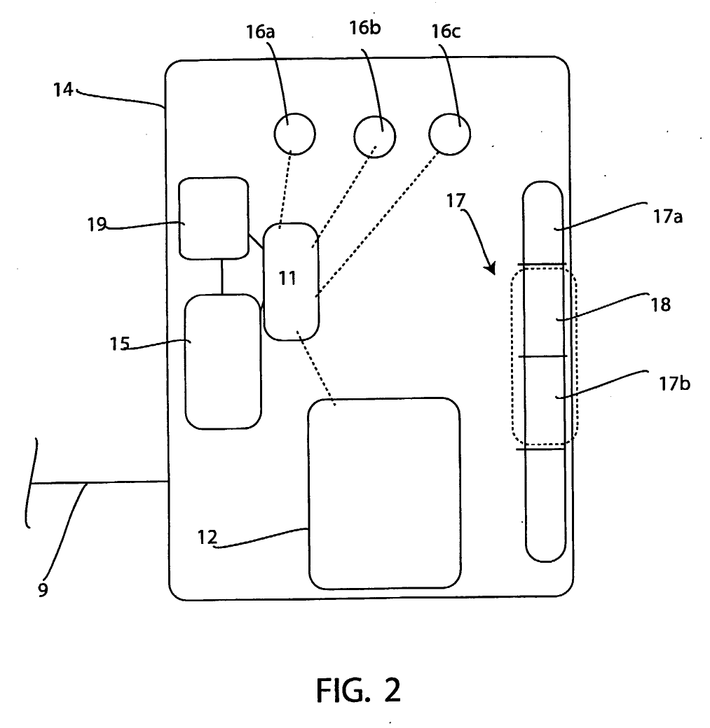

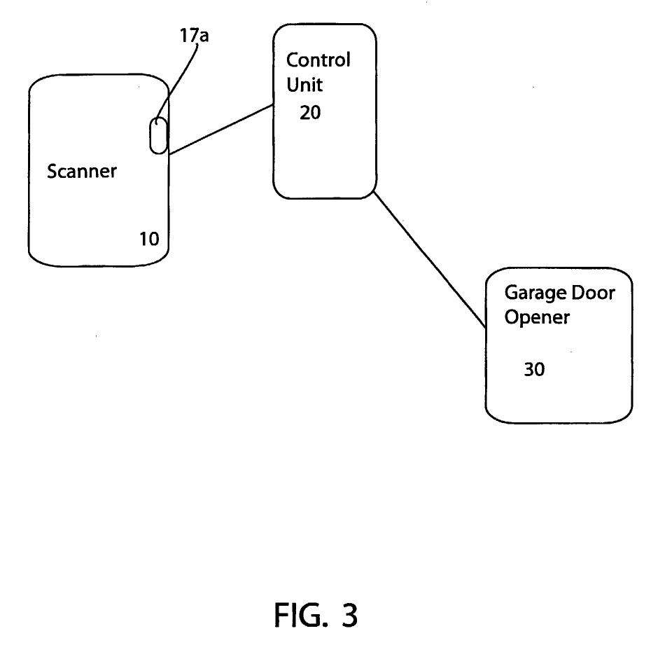

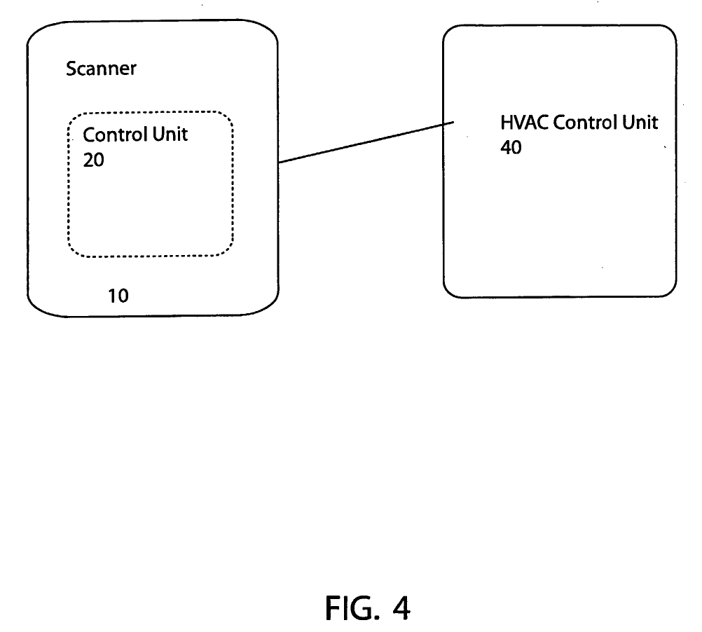

As shown in FIG. 2, body or housing 14 can be used to house at least one processor 11 and at least one communication device such as a transmitter or a receiver and/or a transceiver 15 disposed in body 14 and in communication with pad 12. There can also be at least one wire-based communication port 17, or even two communication ports 17a, 17b, disposed in body 14 which allows a wired communication between the components housed in body 14 and other components. These two communication ports can be in the form of for example, a telephone jack. For example, communication port 17a can be in wired communication with a remote device such as with a relay unit 20 which then relays this information on to a garage door opener 30 as shown in FIG. 3. Alternatively, as shown in FIG. 4, communication port 17a can be in communication with a relay unit 20 or even directly with a set of controls for a heating and cooling control unit 40 which can be used to control the heating and cooling unit inside a household. Thus, in this embodiment, the device operates as a secure biometric control for a thermostat inside of a household. In this embodiment as shown in FIG. 4, the control unit is essentially integrated into the biometric device and disposed inside of housing 14 so that the processor 11, the communication device 15, and the memory unit 19 which are formed integral with the scanner device 10 can operate as the control unit 20. This feature is used instead of having a remote control unit with separate components. Communication port 17b can be included in a phone jack, a CAT 5 ethernet connection or any other multi-line device wherein at least one line is connected to port 17b wherein that line is for communication and an additional line can be connected to a power connection 18 inside of the phone jack or CAT 5 line wherein that power connection can be used for powering the remote keypad by sending power through the connected telephone line or ethernet connection. This view also shows that the housing is fed with a power supply which can be fed in the form of a power cord 9 into the system. There can also be an optional infrared or IR port 17c for reading infrared information from a keypad.

In both the garage door opener, and in the thermostat embodiments, the control unit can be either integrated into and disposed inside of housing 14, as shown in FIG. 4, or disposed remotely in a separate housing as shown in FIG. 3.

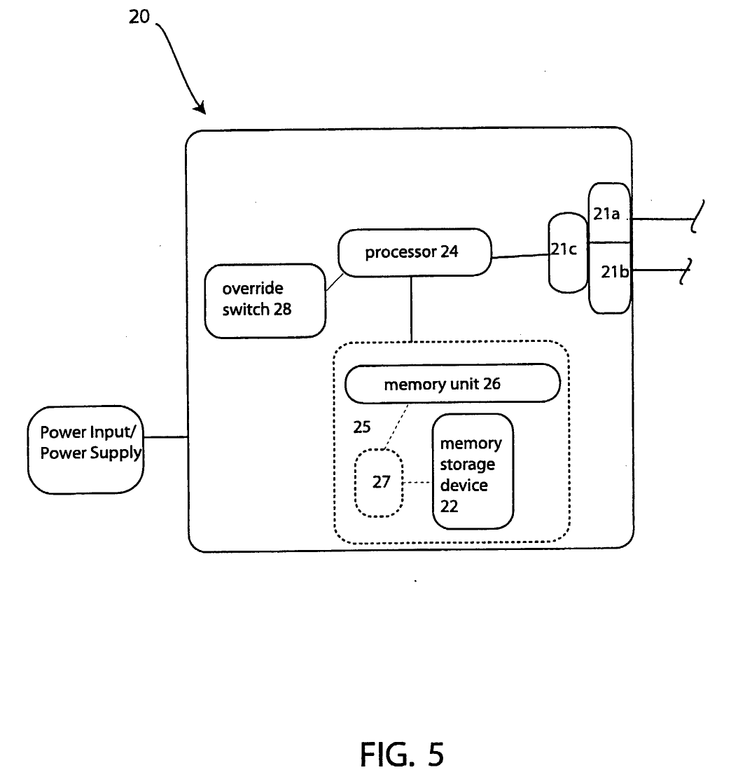

One of the benefits of this device is that it can be in the form of a simple biometric reading device which can be in communication with remote devices which include more complex communication equipment. For example, as shown in FIG. 5 relay unit or control unit 20 can be in the form of a computer or a computing device having a communication element 21, which can be formed as either a first wired communication port 21a for communication with the scanner 10, and a second wired communication port 21b for communication with a remote device such as a garage door opener. Alternatively, there can be a transceiver 21c for wireless communication with either of these devices. Included in the control unit can be a memory storage device 22, a processor 24, a memory unit 26 which can be a RAM or EEPROM or any other known memory unit, wherein this memory storage device 22 and memory unit 26 can be formed as a single memory component 25 which can be used to store a database or set of data information 27 which includes information relating to the biometric identity of a particular user or party. This information can be stored in storage device 22 and then uploaded into memory unit 26 when necessary or stored in universal memory unit 25, wherein universal memory unit 25 acts as a flash memory. This device can also include a power supply, and a manual override switch 28, which can be used to activate override the biometric information and activate the device such as the garage door opener 30 or the HVAC control unit 40. This biometric information can be inserted or uploaded into this data information 27 through the use of a remote programming keypad device 50 either wirelessly, through transceiver 15 or through wired connection via port 17a. Keypad device 50 can also receive power from a power port 18 disposed in housing 14 wherein the housing unit 14 receives power from a wired connection.

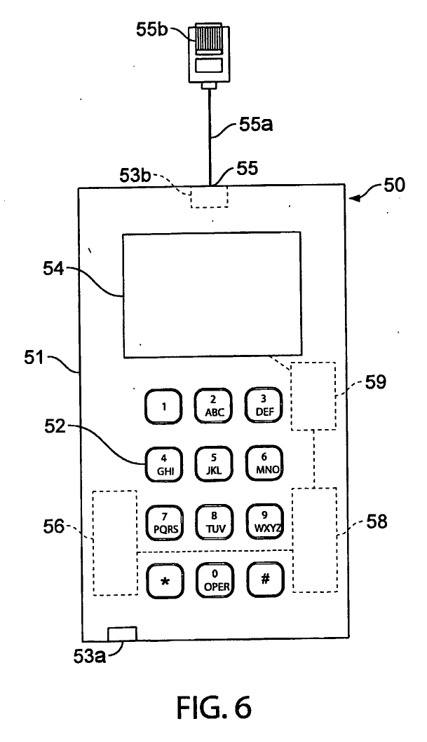

Keypad device 50 is shown in FIG. 1 and is also shown in greater detail in FIG. 6. Keypad 50 is in the form of a non powered keypad that receives power from fingerprint pad housing 14 via power port 18. Keypad device 50 can include a keypad housing 51, a keypad 52 at least partially disposed in the housing, a power receiving port 53a coupled to the housing, a LCD display 54 coupled to the housing, a wire connection port 55 coupled to the housing for the transmission of information or data to biometric unit 10. The communication means or system in this device can be in the form of a wire communication line 55a having a jack connection 55b coupled to line 55a. As shown in this view, a power receiving port 53b can be disposed adjacent to communication port 55 so that a communication line such as a telephone line can deliver both power and communication to the remote keypad device 50.

Disposed inside of housing 51 can be a processor 56, a memory unit 57 in communication with processor 56, and a transceiver 58 for wireless communication in communication with one or more of these components to communicate information from the processor, or the memory unit to either relay unit 20, or transceiver 15 inside of fingerpad housing 14. This remote keypad can be used for updating data stored in either the biometric device 10 or in the relay unit 20. For example, this keypad can be used to program in new users or, for adjusting settings in the relay device 20 or in biometric device 10.

For example, once this keypad device 50 is connected, the user can enroll his or her biometric information such that this biometric information is then stored inside of relay 20 or inside of biometric device 10.

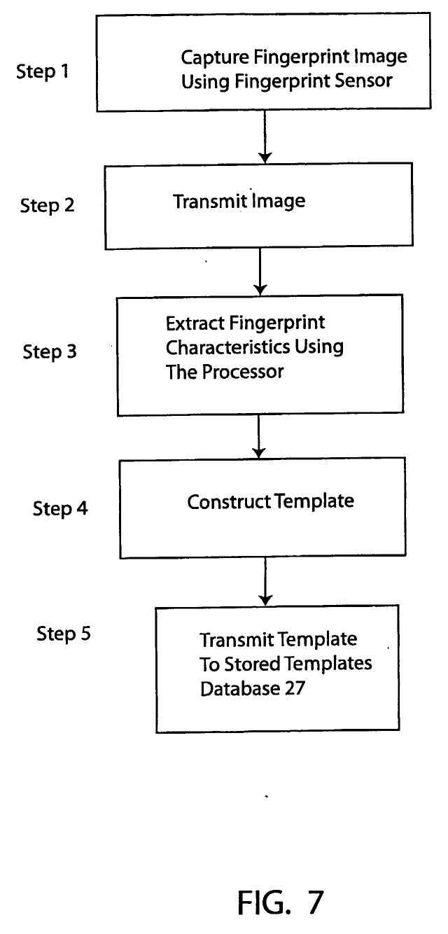

This enrollment process is shown in FIG. 7. In this case, the enrollment includes a process wherein in step 1, a user places his or her finger onto fingerprint pad 12 to capture a fingerprint image. Next, in step 2, this information relating to this fingerprint image is transmitted to processor 11 which extracts these fingerprint characteristics in step 3. This extraction process involves any known software or code that interprets or converts the unique characteristics of an individual's fingerprint image into a fingerprint template.

In step 4, a template such as a fingerprint template is constructed so that it is created from at least one or even possibly several optical fingerprint samples from the same finger of an individual.

This template is then used for later comparisons for authentication. The template is an encoded representation of that image that is stored in the memory unit and which can then be used to later match with a live fingerprint of a user. Because this information is stored in an encoded format, it cannot be reverse engineered to reconstitute the owner's fingerprint image, thus eliminating security concerns due to theft of the device.

Next, in step 5, the template is transmitted to the database 27 of stored templates.

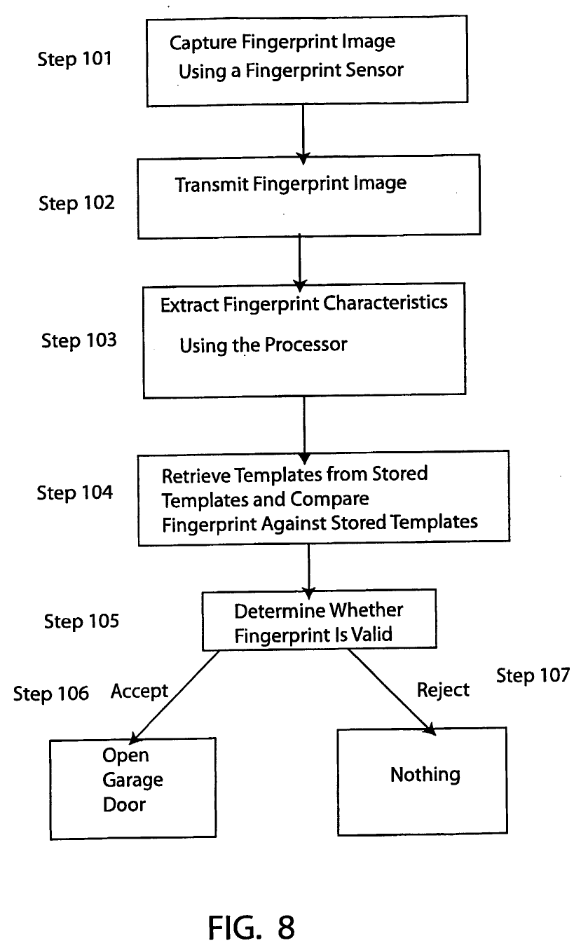

FIG. 8 shows the process and the steps for authentication of a user in the system. For example, with this process, there is step 101 which includes capturing a fingerprint image on the fingerprint sensor. Next, in step 102, this image is transferred to a processor wherein in step 103, the fingerprint characteristics are extracted and then compared in step 104 to the retrieved templates. If the fingerprint is valid, in step 106 the information is sent from relay 20 and then onto either for example, a garage door opener 30, or a HVAC control unit 40 or thermostat to control the heating and cooling of a room. Alternatively, in step 107 the system can reject the biometric information wherein the fingerprint template has too many differences between the template stored therein and the read fingerprint. At this point, the user's fingerprint is rejected and the additional system components are not operated.

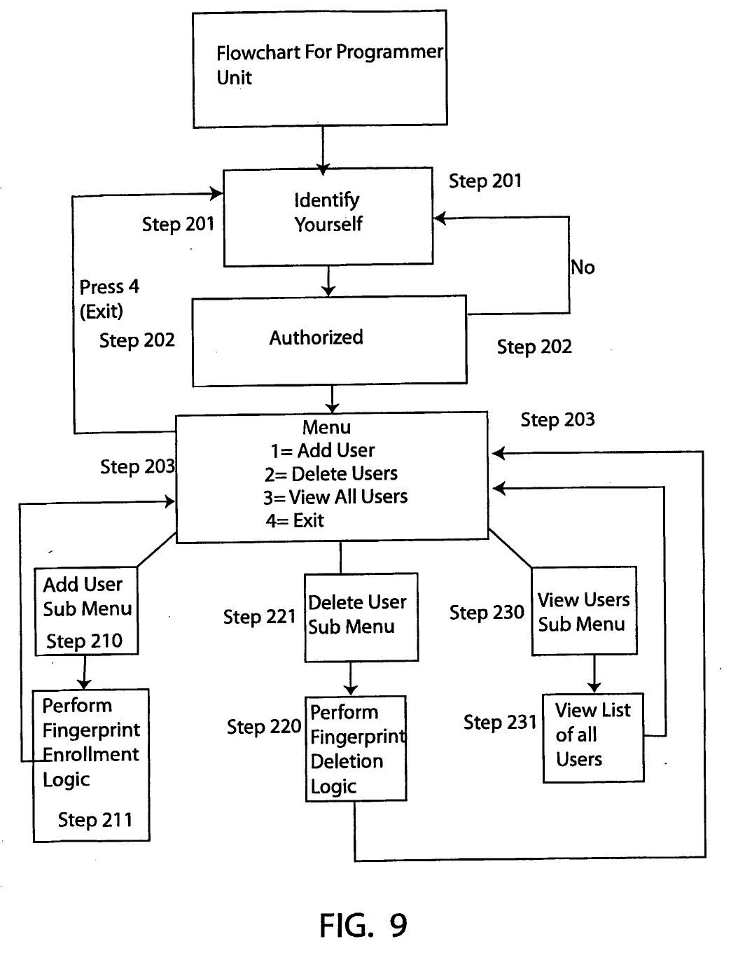

Alternatively, the process can proceed as shown in FIG. 9. In this process, in step 201, a user would identify himself or herself, by placing his or her finger on the fingerpad 12. Next, in step 202 the system would determine whether the user is authorized or has been preregistered into the system. Next, provided the handheld keypad device 50 is coupled to or in communication with fingerpad device 10, then in step 203, a menu is presented on keypad device 50 so that a user can select one of the following options: 1) add a user; 2) delete a user; 3) view all users; or 4) exit the system. Alternatively, if the user has not preregistered with the system, the user would otherwise not be authorized to interact with the system, then the process would return back to step 201.

If none of the user's have been authenticated, the first user could then log into the system by typing in a preselected pin number or identification code into keypad device 50 so that the user would then be authenticated or authorized to proceed onto step 203 wherein the user could then select from the menu presented on LCD display 54. Once the user has completed step 203, next, the system would proceed with one of the following procedures. First if a user selected option 1 the process would proceed to step 210 wherein the user would be presented with an add user sub menu. In this step, the user could then add the user in a similar or in the same manner as described in the process above, which includes step 211 wherein the system including either the biometric device 10 or the relay unit 20 performs a set of fingerprint enrollment logic to enroll the user. The system would then proceed back to step 203 wherein the keypad device would then present the user with the original menu.

Alternatively, if the user selects option 2, the system would then proceed onto step 220 wherein the user would be presented with a sub-menu wherein the user could delete himself or another user from the sub-menu. Next, in step 221, the system would delete the template or data relating to the fingerprint biometrics of a user. The user's information would also be deleted as well. After this step is completed, the user could then return to step 203.

If the user selects option 3, the system would proceed to step 230, wherein the user would be presented with a view users sub menu wherein the user could in step 231 view a list of all of the users and their characteristics. The user could then return back to step 203.

Once at step 203, the user could alternatively press option 4 wherein the system would proceed back to the beginning which is essentially step 201.

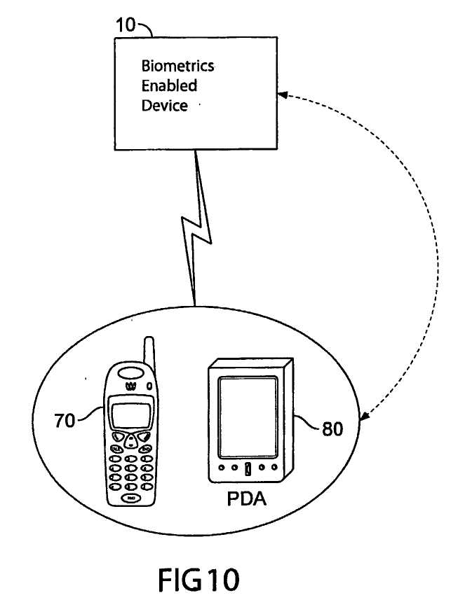

In another alternative embodiment, the keypad device could communicate via an infrared communication system or instead of using the keypad device 50, as shown in FIG. 10, a user could communicate via either a cell phone 70 or a PDA device 80 through any known communication means such as 802.11b, 802.g, 802.11a, wireless transmission, bluetooth transmission, or via in infrared communication port and (IRDA) as is known in the art.

Some of the benefits of the above disclosed device are that it does not require the services of a central alarm station, computer or special equipment to operate. In addition on the biometric device itself 10 there is no requirement for special keys or a keypad which can result in a more costly device. This device can also improve on the security of the device because the only way to access or alter user requirements or stored user templates is through an external particular keypad which can be the only device that can be used to access this stored information. Thus, this device prevents unauthorized users from short circuiting the controls, guessing of codes, or other type of attempts to breach security in the device.

Some of the additional benefits of these devices are that these devices can be easy to use, universal so that they are.

Accordingly, while a few embodiments of the present invention have been shown and described, it is to be understood that many changes and modifications may be made thereunto without departing from the spirit and scope of the invention as defined in the appended claims.

What is claimed is:

1. A biometric device comprising:
a) a scanner for reading a user's fingerprint;
b) at least one communication device in communication with said scanner;
c) a control unit in communication with said scanner, said control unit for receiving biometric information from said scanner, said control unit for controlling a remote device; and
d) a remote keypad, which can selectively communicate with said scanner, wherein said remote keypad can be used to adjust controls in said control unit to perform at least one of the following functions: selectively add a user, selectively delete a user or to review a list of users enrolled.

2. The device as in claim 1, wherein said remote keypad is a non-powered keypad and wherein said remote keypad includes at least one keypad communication device for communicating with said at least one communication device of said scanner.

3. The device as in claim 2, wherein said at least one keypad communication device includes a communication port and a wire cable wherein said wire cable includes at least one wire communication line and at least one power line wherein said at least one wire communication line and said at least one power line can be coupled to said scanner to communicate with said scanner and to receive power from said scanner.

4. The device as in claim 1, wherein said at least one scanner includes a scanner housing, a scanner fingerpad coupled to said scanner housing, at least one memory element, a processor in communication with said scanner fingerpad, said at least one memory element and said at least one communication device said processor for processing information received from said scanner fingerpad.

5. The device as in claim 4, wherein said at least one communication device is in the form of a wireless transceiver.

6. The device as in claim 4, wherein said at least one communication device is in the form of a wired port and a wire line for communicating with said remote keypad.

7. The device as in claim 4, wherein said at least one communication device is in the form of a infrared port for receiving and sending information to said remote keypad.

8. The device as in claim 1, wherein said remote keypad is in the form of a cell phone.

9. The device as in claim 1, wherein said remote keypad is in the form of a personal organization device such as a PDA.

10. The device as in claim 4, wherein said control unit is disposed in said scanner housing.

11. The device as in claim 4, wherein said control unit is disposed outside of said scanner housing.

12. The device as in claim 1, wherein said control unit is in communication with a thermostat, to control a user's access to said thermostat.

13. The device as in claim 1, wherein said control unit is in communication with a garage door opener, to control a user's access to opening or controlling a garage door.

14. The device as in claim 1, wherein said remote keypad further comprises an LCD display.

15. A biometric device comprising:
a) at least one scanner for reading a user's fingerprint, wherein said at least one scanner comprises:
i) a scanner housing;
ii) a scanner fingerpad coupled to said scanner housing;
iii) at least one memory element disposed within said scanner housing;
iv) a processor disposed in said scanner housing and in communication with said scanner fingerpad, said at least one memory element and said at least one communication device said processor for processing information received from said scanner fingerpad;
b) at least one communication device in communication with said at least one scanner;
c) a control unit in communication with said scanner, said control unit for receiving biometric information from said at least one scanner, said control unit for controlling a remote device; and
d) a remote keypad, which can selectively communicate with said scanner, wherein said remote keypad can be used to adjust controls in said control unit to perform at least one of the following functions: selectively add a user, selectively delete a user or to review a list of users enrolled; and
e) a garage door opener, in communication with said control unit, wherein a user can selectively open or close a garage door only after being authenticated by using the following process: placing a finger on said scanner, scanning the finger for a fingerprint, having scanned fingerprint information sent onto said control unit, said control unit comparing said scanned fingerprint information to a fingerprint template stored in said control unit, and then selectively authenticating said user if said scanned fingerprint information is matched with said stored fingerprint template, so that said user can open a garage door.

16. A biometric device comprising:
a) at least one scanner for reading a user's fingerprint, wherein said at least one scanner comprises:
i) a scanner housing;
ii) a scanner fingerpad coupled to said scanner housing;
iii) at least one memory element disposed within said scanner housing;
iv) a processor disposed in said scanner housing and in communication with said scanner fingerpad, said at least one memory element and said at least one communication device said processor for processing information received from said scanner fingerpad;
b) at least one communication device in communication with said at least one scanner;
c) a control unit in communication with said scanner, said control unit for receiving biometric information from said at least one scanner, said control unit for controlling a remote device; and
d) a remote keypad, which can selectively communicate with said scanner, wherein said remote keypad can be used to adjust controls in said control unit to perform at least one of the following functions: selectively add a user, selectively delete a user or to review a list of users enrolled; and
e) a thermostat, in communication with said control unit, wherein a user can selectively change a temperature in a room only after being authenticated by using the following process: placing a finger on said scanner, scanning the finger for a fingerprint and then having scanned fingerprint information sent onto said control unit, said control unit comparing said scanned fingerprint information to a fingerprint template stored in said control unit, and then selectively authenticating said user if said scanned fingerprint information is matched with said stored fingerprint template, so that said user can adjust a temperature setting on said thermostat.
